(19) United States
(12) Patent Application Publication
(10) Pub. No.: US 2022/0268260 A1
(43) Pub. Date: Aug. 25, 2022

(54) METHOD OF OFFSHORE MOUNTING A WIND TURBINE HAVING A SERVICE PLATFORM

(71) Applicant: Siemens Gamesa Renewable Energy A/S, Brande (DK)

(72) Inventor: Johnny Soerensen, Videbaek (DK)

(21) Appl. No.: 17/674,088

(22) Filed: Feb. 17, 2022

(30) Foreign Application Priority Data
Feb. 24, 2021 (EP) 21158914.8

(51) Int. Cl. F03D 13/25; F03D 13/10; F03D 80/80; B63B 35/44

(52) U.S. Cl. CPC F03D 13/25; F03D 13/10; F03D 80/88; B63B 35/44; F05B 2240/95

(57) ABSTRACT

A method of offshore mounting a wind turbine is provided. The wind turbine includes a foundation, a tower, a nacelle and a plurality of blades. The method includes the steps of: a) mounting the foundation on or above a sea ground; b) mounting the tower directly to the foundation, wherein the tower comprises a docking device for docking a service platform, which is configured to be accessed by maintenance personnel; c) mounting the nacelle to the tower; and d) mounting the plurality of blades to the nacelle.

### CROSS-REFERENCE TO RELATED APPLICATIONS

This application claims priority to European Application No. 21158914.8, having a filing date of Feb. 24, 2021, the entire contents of which are hereby incorporated by reference.

### FIELD OF TECHNOLOGY

The following relates to a method of offshore mounting a wind turbine, and to a wind turbine.

### BACKGROUND

A conventional wind turbine comprises a foundation, a tower, a nacelle and a plurality of blades. A transition piece is arranged as a kind of adapter between the foundation and the tower. A service platform is arranged at an upper portion of the transition piece. In the conventional wind turbine, the foundation, the transition piece and the tower are nested into each other. The conventional wind turbine is mounted by steps of mounting the foundation on or above a sea ground; mounting the transition piece on top of the foundation, and mounting the tower on top of the transition piece. Eventually, the nacelle is mounted to the tower, and the plurality of blades is mounted to the nacelle. In another conventional wind turbine, the wind turbine comprises a jacket foundation, to which a service platform is integrally mounted before mounting the tower thereto.

In both of these conventional art wind turbines, the service platform is mounted to the foundation. This needs additional structures and/or cost extensive offshore installation time.

### SUMMARY

An aspect relates to a simplified and less costly method of offshore mounting a wind turbine having a service platform.

According to a first aspect of embodiments of the invention, a method of offshore mounting a wind turbine is provided. The wind turbine comprises a foundation, a tower, a nacelle and a plurality of blades. The method comprising steps of: a) mounting the foundation on or above a sea ground; b) mounting the tower directly to the foundation, wherein the tower comprises a docking device for docking a service platform, which is configured to be accessed by maintenance personnel; c) mounting the nacelle to the tower; and d) mounting the plurality of blades to the nacelle. In the context of embodiments of the present invention, the term “docking device” can comprise a bolted connection, a welded connection, a latching mechanism or any other suitable means which is configured to dock the service platform to the tower. In case of a welded connection, the service platform is integrally formed to the tower.

Contrary to the conventional wind turbines, the service platform is mounted on the tower so that offshore installation time as well as costs of the structure are reduced. Furthermore, the service platform can be (onshore) pre-installed at the tower. Compared thereto, a prior art service platform cannot be pre-installed at the foundation, because a piling or hammering action for installing the foundation in the sea ground would cause excessive forces and loads on the service platform so that the same could be damaged. With embodiments of the present invention, the service platform can readily be pre-installed on the tower in a save and cost-efficient manner.

The service platform can be provided with a footprint (when loaded on the vessel) which is similar to an existing footprint of sea fasteners of the tower. Thereby, a vessel deck space on a jack-up vessel or floating crane installation vessel can be saved.

The service platform supports easy offshore access to the wind turbine and saves costs compared to traditional solutions. The platform can easily be replaced together with the nacelle by a crane, for example if a complex maintenance work is required.

In an embodiment, the foundation is mounted as an integral part, in particular as a monopile. In an embodiment, the tower is mounted as an integral part. The installation is simplified if only two separate parts are mounted to each other.

In an embodiment, the wind turbine does not comprise any separate unit, in particular no transition piece, between the foundation and the tower. If the foundation and the tower are directly connected without any additional transition piece, the costs of the wind turbine having the service platform are further reduced both in terms of the manufacture and installation parameters. The foundation design of offshore wind turbines can be optimized. The arrangement of the service platform at the tower further enables an optimized adaption to future offshore wind turbines and foundations without transition piece.

In an embodiment, the tower is directly mounted to the foundation by at least one of a flange connection, of bolts having different orientations with respect to a tower axis, a slip-joint connection, and a wedge connection. In the slip-joint connection, the tower has a first tube which is mounted to the foundation having a second tube, wherein one of first and second tubes has a diameter which is larger than a diameter of the other one of the first and second tubes, wherein the one of the first and second tubes having the larger diameter is put over and guided by the other one of the first and second tubes, and a wedge connection. Fastening the tower to the foundation is made secure and fast. The slip-joint connection allows larger tolerances so that an installation at high wind speeds or the use of floating vessel, which can be slightly moved due to waves, wind, etc., can be facilitated. The slip-joint connection enables an easier and much faster installation process compared to a bolted flange-to-flange connection. By use of the slip-joint connection, no service personal is required at the site of mounting the nacelle to the tower. Thus, the slip-joint connection enables a safer approach.

In an embodiment, the service platform is already docked, on-shore, to the docking device when the tower is directly mounted to the foundation. In addition, various equipment on the service platform can be pre-installed or installed offshore, preferable pre-installed on-shore for permanent components. Temporary equipment can also be pre-installed on-shore or on quayside. The equipment can be decommissioned offshore after use such as diesel generator and tools and equipment for installation. All pre-installed equipment can be tested on-shore to enable maximum relatability under offshore installation and termination of electrical infrastructure. Offshore installation time is reduced compared to the conventional art. In an embodiment, the service platform is permanently docked, preferable on-shore, to the tower.

In an embodiment, the service platform is foldable docked to the tower. In an embodiment, the service platform is unfolded by activators which are remotely operated. Thereby, vessel space can be saved so that a vessel can carry a high number of towers at the same time.

According to a second aspect of embodiments of the invention, a wind turbine comprises a foundation, a tower, a nacelle and a plurality of blades, wherein the tower comprises a docking device for docking a service platform which is configured to be accessed by maintenance personnel.

In an embodiment, the foundation is an integral part, in particular a monopile, and/or the tower is an integral part. In an embodiment, the wind turbine does not comprise any separate unit, in particular no transition piece, between the foundation and the tower.

In an embodiment, the tower is directly mounted to the foundation by at least one of a flange connection, of bolts having different orientations with respect to a tower axis, a slip-joint connection, and a wedge connection. In the slip-joint connection, the tower has a first tube which is mounted to the foundation having a second tube, wherein one of first and second tubes has a diameter which is larger than a diameter of the other one of the first and second tubes, wherein the one of the first and second tubes having the larger diameter is put over and guided by the other one of the first and second tubes

In an embodiment, the service platform is foldable docked to the docking device. In an embodiment, the service platform is unfoldable, i.e., configured to be unfolded, by activators.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION

Some of the embodiments will be described in detail, with reference to the following figures, wherein like designations denote like members, wherein:

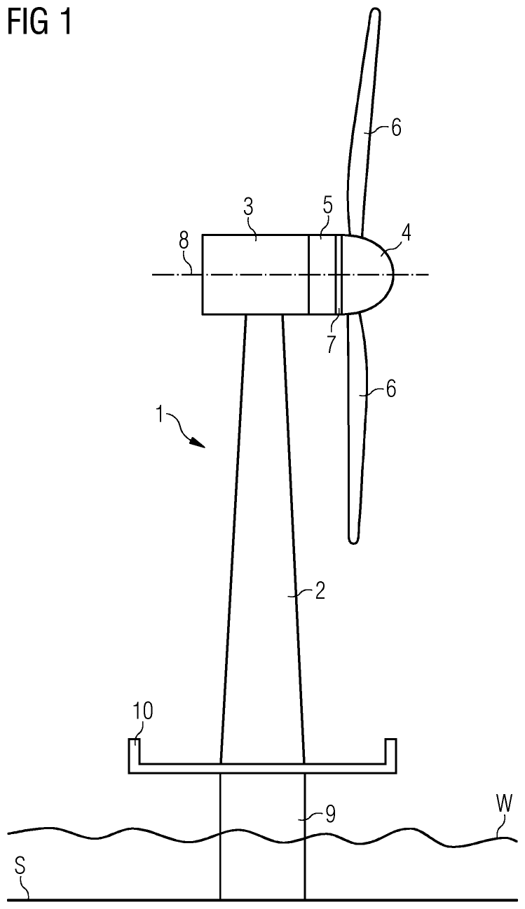

FIG. 1 shows a wind turbine and the different elements thereof;

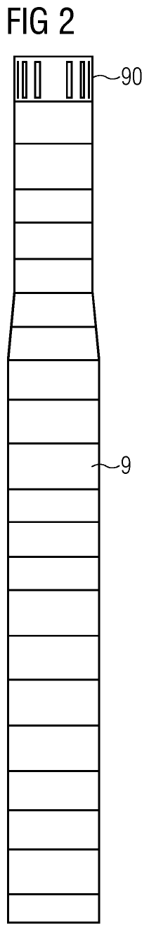

FIG. 2 shows a foundation of a wind turbine according to an embodiment;

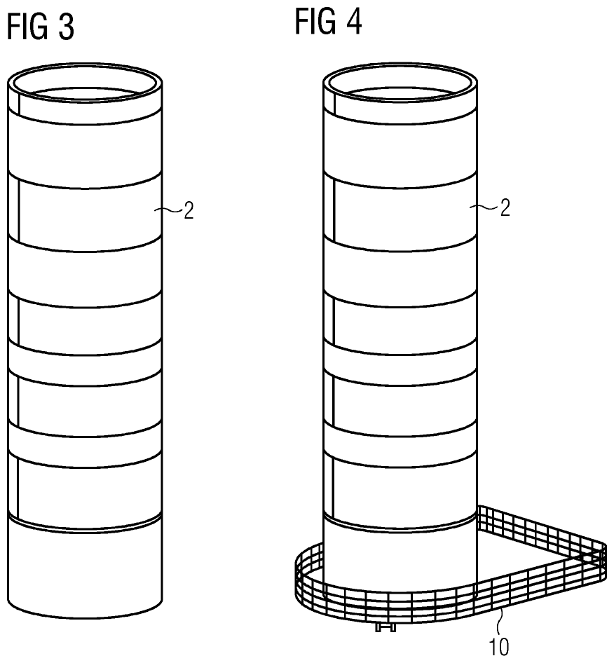

FIG. 3 shows a tower of a wind turbine still without service platform;

FIG. 4 shows the tower of the wind turbine according to an embodiment with service platform;

FIG. 5 shows the foundation and the tower according to an embodiment during mounting;

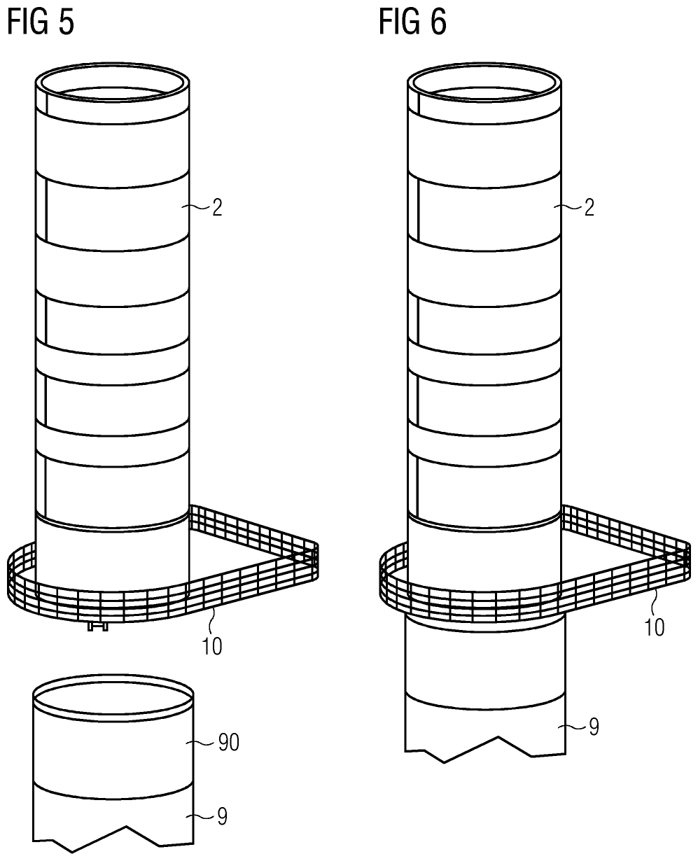

FIG. 6 shows the foundation and the mounted tower according to the embodiment;

FIG. 7 shows a service platform of a wind turbine according to an embodiment;

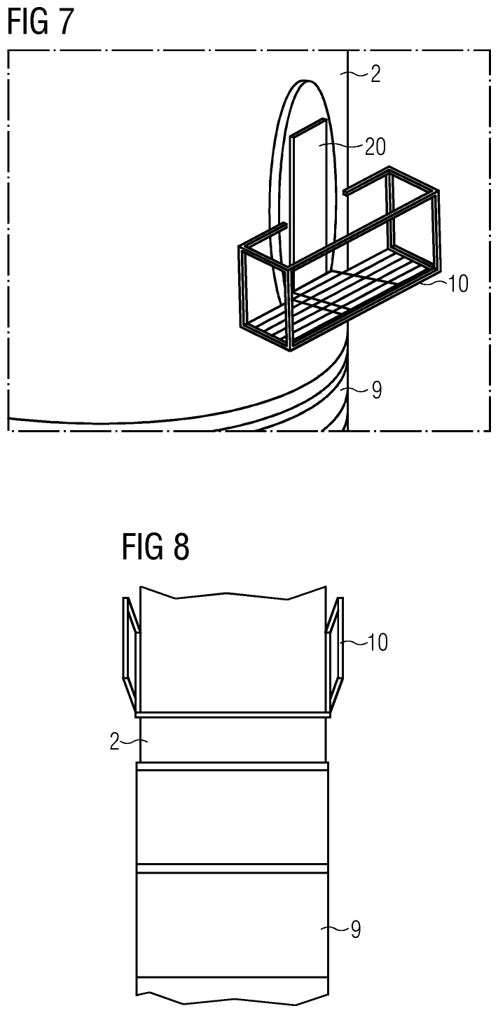

FIG. 8 shows a folded service platform of a wind turbine according to an embodiment;

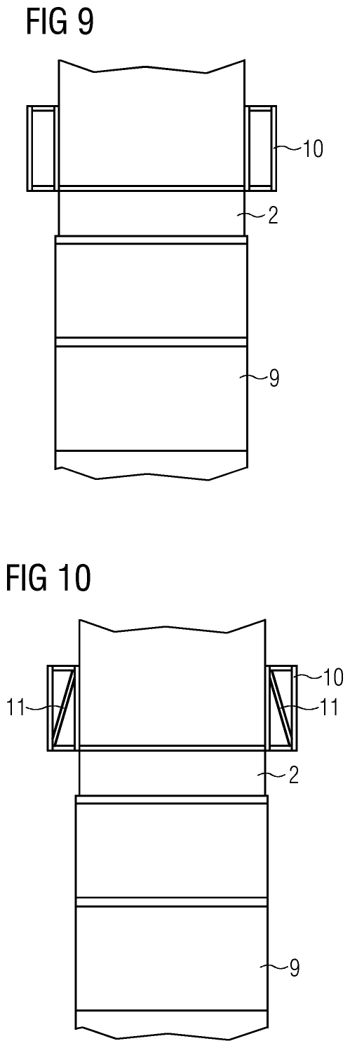

FIG. 9 shows the unfolded service platform of the wind turbine according to the embodiment; and

FIG. 10 shows an unfolded service platform of a wind turbine according to another embodiment;

FIG. 11 shows a flange connection between the tower and the foundation according to an embodiment; and

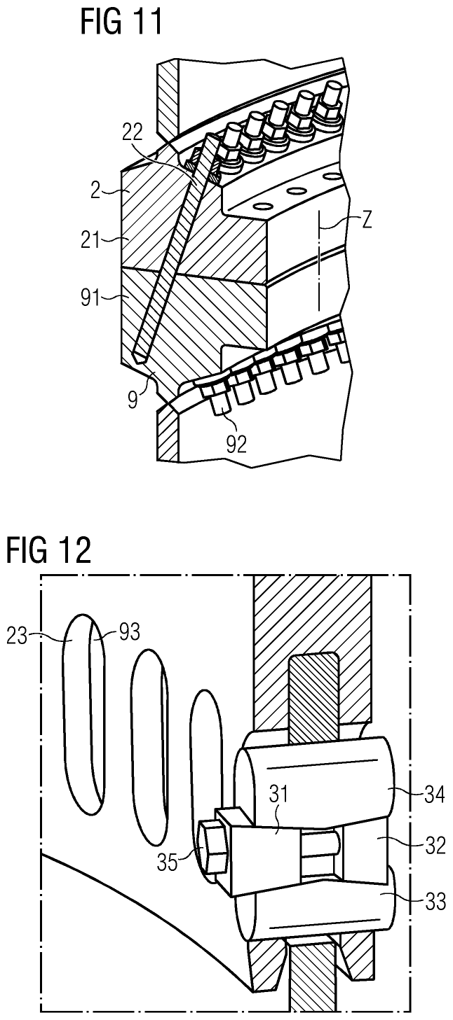

FIG. 12 shows a wedge connection between the tower and the foundation according to an embodiment.

### DETAILED DESCRIPTION

FIG. 1 shows a wind turbine 1. The wind turbine 1 comprises a nacelle 3 and a tower 2. The tower 2 comprises a docking device for docking a service platform 10, which is configured to be accessed by maintenance personnel. The docking device can be formed by a bolted or welded connection or any other suitable means. The tower 2 is directly mounted to a foundation 9 which is installed before on a target position in a seabed S below a waterline W. The nacelle 3 is mounted at the top of the tower 2. The nacelle 3 is mounted rotatable with regard to the tower 2 by a yaw bearing. The axis of rotation of the nacelle 3 with regard to the tower 2 is referred to as the yaw axis.

The wind turbine 1 also comprises a hub 4 with three rotor blades 6 (of which two rotor blades 6 are depicted in FIG. 1). The hub 4 is mounted rotatable with regard to the nacelle 3 by a main bearing 7. The hub 4 is mounted rotatable about a rotor axis of rotation 8.

The wind turbine 1 furthermore comprises a generator 5. The generator 5 in turn comprises a rotor connecting the generator 5 with the hub 4. If the hub 4 is connected directly to the generator 5, the wind turbine 1 is referred to as a gearless, direct-driven wind turbine. Such a generator 5 is referred as direct drive generator 5. As an alternative, the hub 4 may also be connected to the generator 5 via a gear box. This type of wind turbine 1 is referred to as a geared wind turbine. Embodiments of the present invention are suitable for both types of wind turbines 1.

The generator 5 is accommodated within the nacelle 3. The generator 5 is arranged and prepared for converting the rotational energy from the hub 4 into electrical energy in the shape of an AC power.

FIG. 2 shows a foundation 9 of a wind turbine 1 according to an embodiment. The foundation 9 is formed as an integral part, in particular as a monopile. The foundation 9 is mounted on or above a sea ground S, and in the embodiment, the foundation 9 is installed on the target position in the sea ground S. The foundation 9 comprises at its upper part a flange connection 90. The flange connection 90 serves to directly connect the tower 2 to the foundation 9, for example by bolts.

FIG. 3 shows a tower 2 of a wind turbine 1 still without service platform 10, and FIG. 4 shows the tower 2 of the wind turbine 1 according to an embodiment with service platform 10. The service platform 10 can be casted if it is made of concrete, or it can be bolted or welded if it is made of steel like in conventional offshore wind turbines. The service platform 10 is arranged at a bottom portion of the tower 2. The service platform 10 can offshore be mounted to the tower 2. The tower 2 is directly mounted to the foundation 9, wherein the tower 2 is an integral part. In particular, the wind turbine 1 does not comprise any separate unit, in particular no conventional art transition piece like, between the foundation 9 and the tower 2. In an embodiment, the service platform 10 is attached to the tower 2 remotely by a crane and secured with pins.

The tower 2 comprises the docking device for docking the service platform 10 which is configured to be accessed by maintenance personnel. In the embodiment of FIG. 4, the service platform 10 is already docked to the docking device when the tower 2 is directly mounted to the foundation 9. The docking device can be a (reversable) bolt connection. Alternatively, the docking device can, for example, be a welded connection so that the service platform 10 is permanently docked, preferable on-shore, to the tower 2.

FIG. 5 shows the foundation 9 and the tower 2 according to an embodiment during mounted. The tower 2 with the service platform 10 can be lifted from a vessel such as a ship on top of the foundation 9 which can be formed as the monopile or another foundation type.

FIG. 6 shows the foundation 9 and the mounted tower 2 according to the embodiment. The tower 2 has been guided to ensure a target position for the bolted flange connection 90 between the foundation 9 and tower 2. When the tower 2 has reached the correct position, the tower 2 has been secured by mounting bolts in the flange connection 90. In a modification, a slip-joint connection can be used to mount to tower 2 to the foundation 9. In this case, the tower 2 has a first tube which is mounted to the foundation 9 having a second tube, wherein one of first and second tubes has a diameter which is larger than a diameter of the other one of the first and second tubes, wherein the one of the first and second tubes having the larger diameter is put over and guided by the other one of the first and second tubes. Alternatively, any other connecting concept can also be used.

Eventually, the nacelle 3 is mounted to the tower 2, and the plurality of blades 6 is mounted to the nacelle 3.

FIG. 7 shows a service platform 10 of a wind turbine 1 according to an embodiment. This service platform 10 is a compact platform. The service platform 10 can be arranged only at a predetermined part of the circumference of the tower 2, for example at that part where a door 20 is arranged. The service platform 10 is a relatively small platform only at a door frame of the door 20 so that a vessel space in a vessel for transporting the tower 2 can be saved.

FIG. 8 shows a folded service platform 10 of a wind turbine 1 according to an embodiment. The service platform 10 is foldable docked to the tower 2. The service platform 10 is folded, for example during transport to save vessel space.

FIG. 9 shows the unfolded service platform 10 of the wind turbine 1 according to the embodiment.

FIG. 10 shows an unfolded service platform 10 of a wind turbine 1 according to another embodiment. The service platform 10 is remotely unfolded from an installation vessel on-shore or offshore by activators 11. The activators 11 can be hydraulic or pneumatic actuators.

FIG. 11 shows a flange connection between the tower 2 and the foundation 9 according to an embodiment. The tower 2 has a tower flange 21, and the foundation 9 has a foundation flange 91, wherein both flanges 21, 91 are mounted to each other by first bolts 22 and second bolts 92. In detail, a number of the first bolts 22 is inserted into the tower flange 21 in a first orientation or inclination angle relative to a tower axis z, and a number of the second bolts 92 is inserted into the foundation flange 91 in a second orientation or inclination angle relative to the tower axis z, wherein the first and second orientations are different from each other. As shown in FIG. 11, such configuration can be designated as an X-bolt flange connection.

FIG. 12 shows a wedge connection between the tower 2 and the foundation 9 according to an embodiment. The wedge connection comprises a first wedge member 31, a second wedge member 32, both being movably received in a first wedge receiving member 33 and a second wedge receiving member 34. The members 31, 32, 33, 34 are in turn received in an elongated tower hole 23 and an elongated foundation hole 93, which are congruent to each other.

The first and second wedge members 31, 32 can be tightened against the first and second wedge receiving members 33, 34 by tightening a wedge bolt 35. By tightening the wedge bolt 35, the first and second wedge receiving members 33, 34 are in turn tightened against the elongated tower hole 23 and the elongated foundation hole 93.

By embodiments of the present invention, the service platform 10 can be mounted on-shore on preassembly site so that cost intensive offshore installation time is reduced. Any desired service platform installations and equipment can be pre-installed prior to offshore installation. The design without transition piece requires less interfaces at the foundation 9. For example, a David crane can be linked to internal controls and tested in advance.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of offshore mounting a wind turbine, the wind turbine comprising a foundation, a tower, a nacelle and a plurality of blades, the method comprising:
mounting the foundation on or above a sea ground;
mounting the tower directly to the foundation, wherein the tower comprises a docking device for docking a service platform which is configured to be accessed by maintenance personnel;
mounting the nacelle to the tower; and
mounting the plurality of blades to the nacelle.

2. The method according to claim 1, wherein the foundation is mounted as a monopile.

3. The method according to claim 1, wherein the tower is mounted as an integral part.

4. The method according to claim 1, wherein the wind turbine does not comprise a transition piece between the foundation and the tower.

5. The method according to claim 1, wherein
the tower is directly mounted to the foundation by at least one of:
a flange connection having bolts comprising different orientations with respect to a tower axis;
a slip-joint connection, wherein the tower has a first tube which is mounted to the foundation comprising a second tube, wherein one of first and second tubes has a diameter which is larger than a diameter of the other one of the first and second tubes, wherein the one of the first and second tubes comprising the larger diameter is put over and guided by the other one of the first and second tubes; and
a wedge connection.

6. The method according to claim 1, wherein the service platform is already docked, onshore, to the docking device when the tower is directly mounted to the foundation.

7. The method according to claim 1, wherein the service platform is permanently docked to the tower.

8. The method according to claim 1, wherein the service platform is foldable docked to the tower.

9. The method according to claim 8, wherein the service platform is unfolded by activators which are remotely operated.

10. A wind turbine comprising a foundation, a tower, a nacelle and a plurality of blades, wherein the tower comprises a docking device for docking a service platform which is configured to be accessed by maintenance personnel.

11. The wind turbine according to claim 10, wherein the foundation is a monopile, and/or the tower is an integral part.

12. The wind turbine according to claim 10, wherein the wind turbine does not comprise a transition piece between the foundation and the tower.

13. The wind turbine according to claim 10, wherein the tower is directly mounted to the foundation by at least one of:
a flange connection, by bolts comprising different orientations with respect to a tower axis; and
a slip-joint connection, wherein the tower has a first tube which is mounted to the foundation comprising a second tube, wherein one of first and second tubes has a diameter which is larger than a diameter of the other one of the first and second tubes, wherein the one of the first and second tubes comprising the larger diameter is put over and guided by the other one of the first and second tubes; and
a wedge connection.

14. The wind turbine according to claim 10, wherein the service platform is foldable docked to the docking device.

15. The wind turbine according to claim 14, wherein the service platform is configured to be unfolded by activators.
